(19) United States
(12) Patent Application Publication
(10) Pub. No.: US 2017/0054755 A1
(43) Pub. Date: Feb. 23, 2017

(54) SECURE POLICY MANAGER

(71) Applicant: Avaya Inc., Santa Clara, CA (US)

(72) Inventors: Harsh V. Mendiratta, East Brunswick, NJ (US); Gordon R. Brunson, Broomfield, CO (US); Rifaat Shekh-Yusef, Belleville (CA)

(21) Appl. No.: 14/832,064

(22) Filed: Aug. 21, 2015

(51) Int. Cl. H04L 29/06

(52) U.S. Cl. CPC H04L 63/20; H04L 63/107

(57) ABSTRACT

An event that changes the security of a communication session between communication endpoints is determined. The event that changes the security of the communication session between the communication endpoints occurs after the communication session is established. For example, the event may be where a user has enabled a speakerphone. In response to determining the event that changes the security of the communication session between the communication endpoints, a message is sent to the communication endpoints that indicates a changed security level. The communication endpoints display the changed security level to the participants of the communication session. For example, the changed security level when the speakerphone is enabled may indicate that the communication session is now unsecure.

### TECHNICAL FIELD

The systems and methods disclosed herein relate to secure communications and in particular to management of secure communications.

### BACKGROUND

The ability to provide secure communications is an essential part of government and corporate communications networks. In many cases, it is imperative that the information presented in a communication session, such as a voice or a video communication session, be highly secure. One way is to let the parties of a communication session know if the communication session is secure by providing a security indication feature that indicates whether the communication session is secure or not. This way, the parties of a communication session will be able to determine if the call is secure. However, current end-to-end call security indication features sometimes do not always provide a proper indication of the level of security for a call. For example, person who is not intended to listen to the communication session may overhear the communication session. In cases like this, the security of the communication session may be compromised without other parties on the communication session having knowledge of the compromise.

### SUMMARY

Systems and methods are provided to solve these and other problems and disadvantages of the prior art. An event that changes the security of a communication session between communication endpoints is determined. The event that changes the security of the communication session between the communication endpoints occurs after the communication session is established. For example, the event may be where a user has enabled a speakerphone. In response to determining the event that changes the security of the communication session between the communication endpoints, a message is sent to the communication endpoints that indicates a changed security level. The communication endpoints display the changed security level to the participants of the communication session. For example, the changed security level when the speakerphone is enabled may indicate that the communication session is now unsecure.

### BRIEF DESCRIPTION OF THE DRAWINGS

FIG. 1 is a block diagram of a first illustrative system for providing security status during communication session in a peer-to-peer environment.

FIG. 2 is a block diagram of a second illustrative system for providing security status during a communication session in a centralized environment.

FIG. 3 is a flow diagram of a process for providing security status during a communication session.

FIG. 4 is a flow diagram of a process managing security policies.

FIG. 5 is a diagram of an illustrative display of security messages on a communication endpoint.

### DETAILED DESCRIPTION

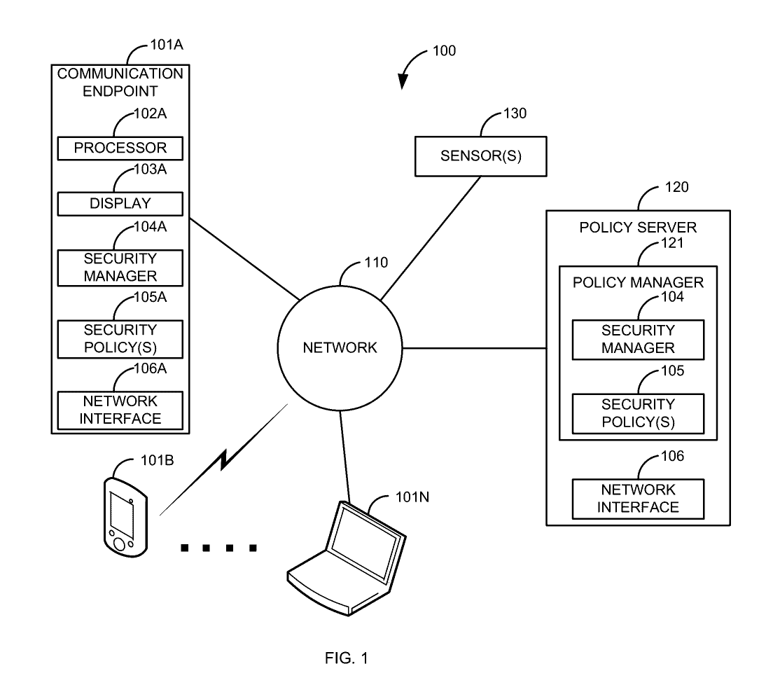

FIG. 1 is a block diagram of a first illustrative system 100 for providing security status during communication session in a peer-to-peer environment. The first illustrative system 100 comprises communication endpoints 101A-101N, a network 110, a policy server 120, and sensors 130.

The communication endpoint 101 can be or may include any communication endpoint that can communicate on the network 110, such as a Personal Computer (PC), a telephone, a video system, a cellular telephone, a Personal Digital Assistant (PDA), a tablet device, a notebook device, a smart phone, a video server, a media server, and the like. As shown in FIG. 1, any number of communication devices 101A-101N may be connected to the network 110.

The communication endpoint 101A further comprises a processor 102A, a display 103A, a security manager 104A, one or more security policies 105A, and a network interface 106A. Although the communication endpoints 101B-101N are not shown comprising the processor 102, the display 103, the security manager 104, the one or more security policies 105, and the network interface 106, the communication endpoints 101B-101N may also comprise all of the elements 102-106 or a subset of the elements 102-106. For example, the communication device 101B may comprise elements 102-106 (although not shown, 102B-106B).

Although not shown, the communication endpoint 101 may comprise other hardware devices for conveying or receiving information, such as a speaker, a microphone, a headset, a video camera, a touch screen, a sensor 130, and/or the like. The other hardware devices may be used in detection of security events and/or for notifying a security status of a communication session. For example, the speaker may be used to convey a security level of a communication session.

Although not shown, the communication endpoints 101 described herein may also include other modules that are used to provide security, such as an encryption module, a secure boot, and/or the like. The encryption module and the secure boot can be used to ensure that each of the communication endpoints 101 is a trusted communication endpoint 101. In order for a communication session to be considered to be secure, each of the communication endpoints 101 need to be trusted communication endpoints 101.

The processor 102 can be or may include any hardware processing device that processes firmware/software, such as a microprocessor, a computer, a multi-core processor, a digital signaling processor, a microcontroller, and/or the like. The display 103 can be or may include any device that can render a display to a person, such as a Liquid Crystal Display (LCD), A Light Emitting Diode (LED) display, a plasma display, a cathode ray tube, a video projector, a touch screen, and/or the like. The display 103 may comprise an indicator, such as a single lamp or LED that conveys whether a call is secure or not.

The security manager 104 can be any hardware/software that can manage the security of a communication session. The security manager 104 can manage the security of one or more communication sessions between any number of communication endpoints 101A-101N.

The one or more security policies 105 can be or may include any rule or policy that defines how security events are managed, displayed, conveyed, and/or the like. The one or more security policies 105 may be downloaded along with the security manager 104 to the communication endpoint 101.

The network interface 106 can be or may include any hardware, in conjunction with firmware/software that can communicate on the network 110. For example, the network interface 106 may be an Ethernet interface, a cellular interface, a fiber optic interface, a wireless interface, a WiFi interface, an 802.11 interface, a wired interface, and/or the like. The network interface 106 may use a variety of protocols, such as the Internet Protocol, Transmission Communication Protocol (TCP), User Datagram Protocol (UDP), SIP, proprietary protocols, video protocols, Instant Messaging (IM) protocols, Web Real-Time Communication (WebRTC) protocol, H.323, Voice over IP (VoIP), and/or the like.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), proprietary protocols, and/or the like. Thus, the network 110 is an electronic communication network configured to carry messages via packets and/or circuit switched communications.

The policy server 120 can be or may include any hardware in conjunction with software that can manage secure communications. The policy server 120 further comprises a policy manager 121 and the network interface 106. The policy manager 121 can be or may include any hardware/software that can manage secure communications. The policy manager 121 further comprises the security manager 104 and the one or more security policies 105. The security policies 105 in the policy manager 121 may include the same or different policies for each of the communication endpoints 101A-101N. The policy manager 121 can download the security manager 104 and/or the security policies 105 to each (or selected ones) of the communication endpoints 101A-101N. Although not shown, the policy manager 121 may also comprise other modules, such as an encryption module.

The sensor(s) 130 can be any sensor that is used to identify events, such as a Radio Frequency Identification (RFID), a card reader, a Global Positioning Satellite (GPS) locators, a camera, a bar code scanner, a Bluetooth beacon or similar device, a voice print identification system, an authentication system, a communication stream analyzer, and/or the like. For example, the sensor 130 may be a card reader in a conference room. The sensor 130 may include a other types of sensors, such as, a door sensor (e.g., a door opening or closing), a detector that detects a person in a nearby area, an motion sensor alarm outside a confidence room, a Global Positioning Satellite (GPS) criteria for a location, and/or the like. For example, an event may be that the call is considered unsecure as long as the conference room is open and/or the call becomes unsecure when the conference room door is opened.

The sensor(s) 130 are shown as separate from the communication endpoint 101 and the policy server 120. However, in some embodiments the sensor(s) 130 may be in the communication endpoints 101A-101N and/or the policy server 120. For example, the sensor 130 may be a video camera or a touch screen in the communication endpoint 101A.

For illustrative purposes, the following exemplary description is for a communication session between the communication endpoints 101A and 101B. Although not shown, the communication session may be established using network elements, such as a proxy server. The communication session may be between two or more of the communication endpoints 101A-101N. The communication session may be a voice, video, multimedia, or Instant Messaging (IM) communication session. The policy manager 121 downloads the security manager 104 and the security policy 105 to the communication endpoint 101A-101B. The downloaded policy security policy 105A may be different than the downloaded security policy 105B.

The communication endpoint 101A establishes a peer-to-peer communication session to the communication endpoint 101B. Once a peer-to-peer communication session is established between the communication endpoints 101A-101B, the security manager 104A determines an event that changes the security of the communication session. The event is determined based on the security policy 105. In response to determining that event that changes the security of the communication session, the communication endpoint 101A sends a changed security level to the communication endpoint 101B.

To illustrate, assume that a voice call has been established between the communication endpoints 101A-101B. For example, using SIP (e.g., the communication endpoint 101A sends a SIP INVITE, receives a SIP 200 OK, and sends a SIP ACK) to establish the SIP voice call. The security policy 105A defines that if one of the communication devices 101A-101B enables a speakerphone that the call is deemed unsecure. A user of the communication endpoint 101A enables a speaker phone in the communication endpoint 101A. In response, the communication endpoint 101A sends a SIP UPDATE message (because the SIP update is an in-dialog SIP message that is more secure than an out-of-dialog SIP message) to the communication endpoint 101B that indicates a change in a security level of the communication session. The change in the security is that the communication session is now unsecure. The communication endpoint 101B displays a message indicating that the call is unsecure because the user of the communication endpoint 101A is now on speaker phone. If the communication endpoint 101N is also on the call, the communication endpoint 101A may also send the message indicating that the call is unsecure to the communication endpoint 101N.

In one embodiment, the sensor 130 may send the event to one or more of the communication endpoints 101. For example, the sensor 130 may be an RFID scanner in a video conference room that includes the communication endpoint 101A. If a person who is not authorized to be on the video call enters the conference room during the video call (e.g., by scanning their RFID card) the RFID scanner can send the event to the communication endpoint 101A. In response to the RFID event, the communication endpoint 101A sends a message to the other communication endpoints 101 on the call indicating the video call is now unsecure because a person who is not authorized to be on the video call is in the conference room.

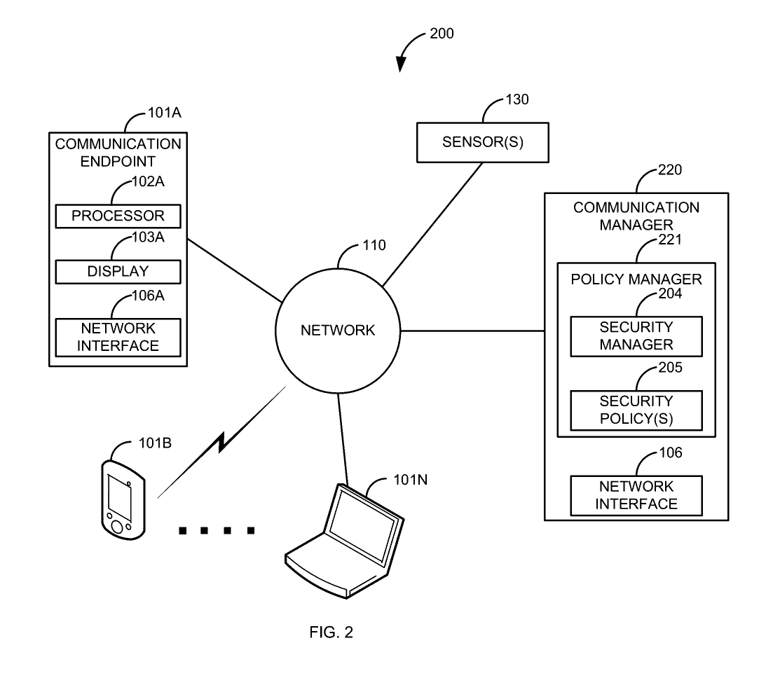

FIG. 2 is a block diagram of a second illustrative system 200 for providing security status during a communication session in a centralized environment. The second illustrative system 200 comprises the communication endpoints 101A-101N, the network 110, a communication manager 220, and the sensor(s) 130. In this embodiment, the communication endpoints 101A-101N includes the processor 102, the display 103, and the network interface 106.

The communication manager 220 can be or may include any hardware coupled with software/firmware that can establish a communication session, such as a Private Branch Exchange, a central office switch, a router, a proxy server, and/or the like. The communication manager 220 further comprises a policy manager 221 and a network interface 106.

The policy manager 221 can be or may include any hardware/software that can manage the security of communication sessions. The policy manager 221 further comprises a security manager 204 and security policy(s) 205. Although not shown, the policy manager 221 may comprise other modules, such as an encryption module.

The security manager 204 is similar to the security manager 104. However, in this embodiment, the security manager 204 is a centralized security manager 204. The security manager 204 manages security for two or more the communication endpoints 101A-101N. Although not shown, the security manager 204 may be distributed. For example, the security manager 204 may reside in the communication manager 220 and in the communication endpoints 101A-101N. Alternatively, the security manager 204 may reside separate from the communication manager 130. For example, on a policy server 120. In one embodiment, the security manager 204 is a Back-to-Back User Agent (B2BUA) that is sequenced into the call/media flow of the communication session.

For illustrative purposes, the following exemplary description is for a communication session that is established between the communication endpoints 101A and 101B via the communication manager 220. However, the communication session may be between two or more of the communication endpoints 101A-101N.

A communication session is established between the communication endpoints 101A-101B. Once the communication session is established, the security manager 204 determines an event that changes the security of the communication session between the communication endpoints 101A-101B. In response, the security manager 204 sends a message indicating that the security level has changed to the communication endpoints 101A-101N.

For example, take the event where a speakerphone is enabled. After the communication session between the communication endpoints 101A-101B is established via the communication manager 220, the user of the communication endpoint 101A enables the speakerphone in the communication endpoint 101A. The status of the enabled speakerphone is sent to the security manager 204 by the communication endpoint 101A. In response to the security policy 205 that indicates that a call is unsecure if one of the communication endpoints 101A-101B is on speakerphone, the security manager 204 determines that the security of the communication session has changed. As a result the security manager 204 sends a message to both the communication endpoints 101A-101B indicating that the security of the communication session is now unsecure.

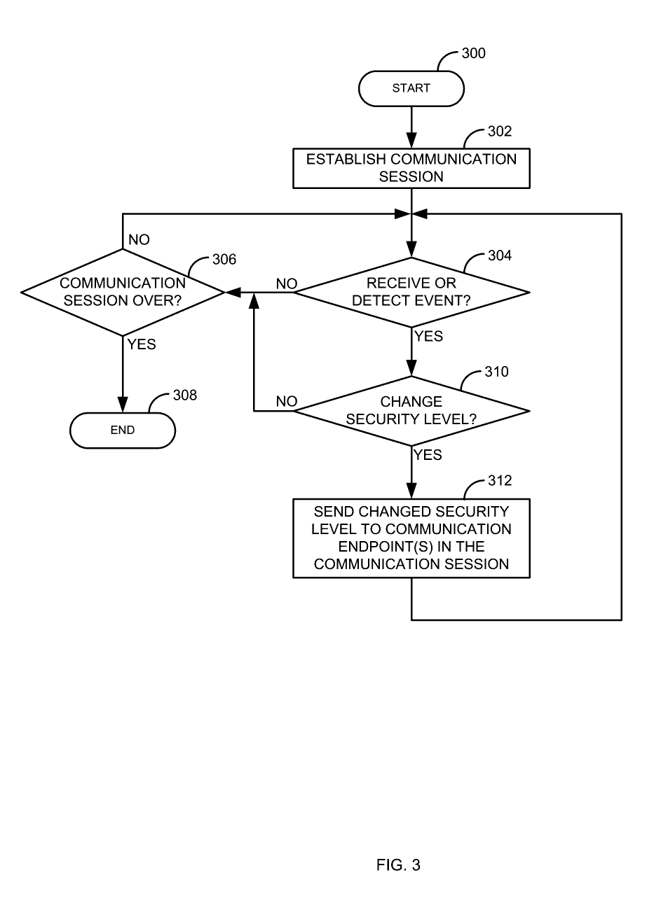

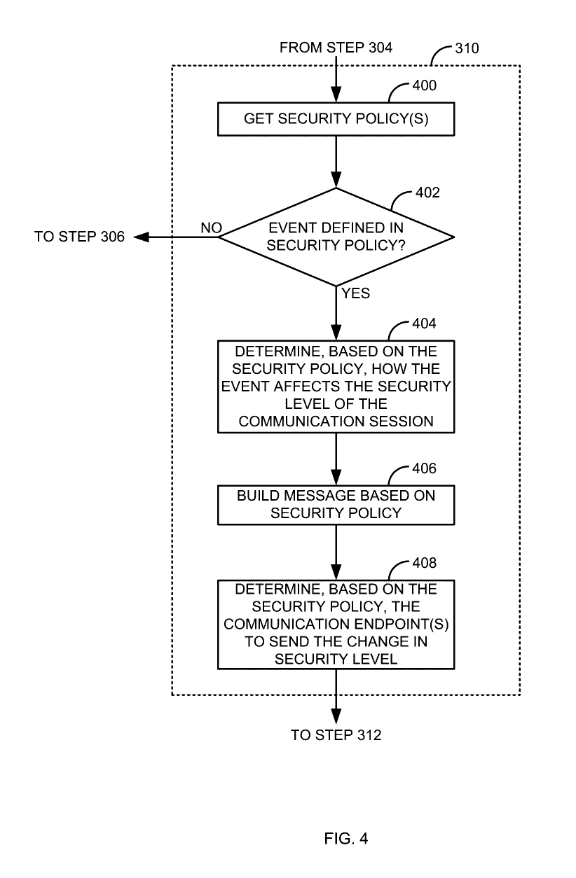

FIG. 3 is a flow diagram of a process for providing security status during a communication session. Illustratively, the communication endpoints 101A-101N, the display 103, the security managers 104/204, the network interface 106, the policy server 120, the policy managers 121/221, the communication manager 220, and the sensors 130, use stored-program-controlled entities, such as a computer, processor 102, which performs the method of FIGS. 3-4 and the processes described herein by executing program instructions stored in a non-transitory computer readable storage medium, such as a memory or disk. Although the methods described in FIGS. 3-4 are shown in a specific order, one of skill in the art would recognize that the steps in FIGS. 3-4 may be implemented in different orders and/or be implemented in a multi-threaded environment. Moreover, various steps may be omitted or added based on implementation.

The process of FIGS. 3-4 will work for the embodiments described in FIGS. 1-2. The process starts in step 300. A communication session is established between two or more (a plurality) of communication endpoints 101 in step 302. For example, an encrypted communication session is established between the communication endpoints 101A-101N.

The security manager 104/204 determines if an event has been received or detected in step 304. The security manager 104/204, in step 304, may receive an event from one of the sensors 130, from another device, from an application, and/or the like. The security manager 104/204, in step 304, may detect an event locally, such as via a speaker or camera.

An event can be any event that can cause a change to a level of security in the communication session. For example, the event can be where a speakerphone has been activated or deactivated in a communication endpoint 101. The event can be where a high signal to noise ratio is detected in an audio stream of one or more of the communication endpoints 101. For example, if the background noise of a caller is high, this may indicate that the person is in an area where others may listen in or view a voice or video communication session. Alternatively, detection of a low signal to noise ratio (where it was previously high) in the audio stream may indicate that the call may now be secure. The event may be a connection or disconnection of a wireless headset to a communication endpoint 101. Connection of a wireless headset can make a call unsecure because another person who is unauthorized may use the headset or the user may move into an unsecure location with the headset. In addition, wireless headsets typically have no encryption or encryption that is too weak to make the wireless stream secure. The wireless headset may use encryption that is not at the same level of the encryption that the communication session has. This results in a less secure communication session. Other events can include a person leaving a secure area, a person entering a secure area, a person entering an unsecure location, a person leaving an unsecure location, a visual detection of another person in a room, detection of an unrecognized or unauthorized face print, an audio detection of the another person speaking (a second person speaking at a communication endpoint 101 where only one is allowed), detection of a specific sound (e.g., a dog barking, car sounds, etc.), detection of an unknown or unauthorized voice print, detection of a local recording on one of the communication endpoints 101, a communication endpoint 101 leaving a secure area, a communication endpoint 101 entering a secure area, and/or the like.

If an event has not been received in step 304, the process determines in step 306 if the communication session is over. If the communication session is over in step 306, the process ends in step 308. Otherwise, if the communication is not over in step 306, the process goes to step 304.

If an event is received or detected in step 304, the process determines in step 310 if the event causes a change in a level of security in step 310. Whether an event causes a change in a security level is based on the security policies 105/205. An event may be specific to a communication endpoint 101. For example, a user of the communication endpoint 101A may cause a change in security when the communication endpoint 101 is on speakerphone (unsecure). However the communication endpoint 101B may not cause a change in the security level when the communication endpoint 101B is on speakerphone. For example, the communication endpoint 101B may be in a secure conference room where being on speakerphone is considered secure. In a peer-to-peer environment, the communication endpoints 101A-101N may have different security policies 105A-105N. In the centralized environment, each communication endpoint 101A-101N may have a separate security policy 205. In some embodiments, all the communication endpoints 101A-101N may use a single security policy 105/205. In some embodiments, only a subset of the communication endpoints 101 may have an associated security policy 105/205.

If the security level is not to be changed in step 310, the process goes to step 306. Otherwise, if the security level is to be changed in step 310, the security manager 104/204 sends, via the network interface 106, the changed security level to the communication endpoint(s) 101 in the communication session in step 312. The communication endpoints 101 then display the security level to the participants of the communication session. For example, a security LED may be turned on or off to convey whether or not the communication session is secure.

In the process of FIG. 3, step 304 is shown as occurring after the communication session is established. However, in some embodiments, step 304 can occur during the establishment of the communication session. For example, if a caller calls from an unsecure location that indicates that the call is unsecure. However, the security level may change (as described in step 310) based on other messages/information that is not passed along with the regular call messages. For example, based on a calendar event indicator that the location is actually secure. Alternatively, other events that may occur during the establishment of a communication session may include an auto speaker phone event (where the speaker phone automatically is in use), where the user's headset is connected during the establishment of the communication session, detection of a local recording, and/or the like.

FIG. 4 is a flow diagram of a process managing security policies 105/205. The process of FIG. 4 is an expanded of step 310 of FIG. 3. After an event is received or detected in step 304, the security manager 104/204 gets the security policy(s) 105/205 in step 400. The security manager 104/204 determines if the event is defined in the security policy(s) 105/205 in step 402. If the event is not defined or does not change the security level in step 402, the process goes to step 306.

Otherwise, if the event is defined and changes the security level, the security manager 104/204 determines, based on the security policy(s) 105/205 how the event affects the security level of the communication session in step 404. How the event affects the security level may be defined in various ways, such as making the communication session secure or unsecure. Alternatively, the security level may have multiple levels, such as secure, potentially unsecure, and unsecure. In one embodiment, a number range is used to indicate the security level (e.g., 1-10). The security level may be based on multiple events. For example, the communication session may not be considered unsecure until two of the communication endpoints 101 have a high signal to noise ratio. Alternatively, the security level may change progressively. For example, a communication session may be determined to be potentially unsecure when a first communication endpoint is on speakerphone and unsecure when two or more of the communication endpoints 101 are on speakerphone.

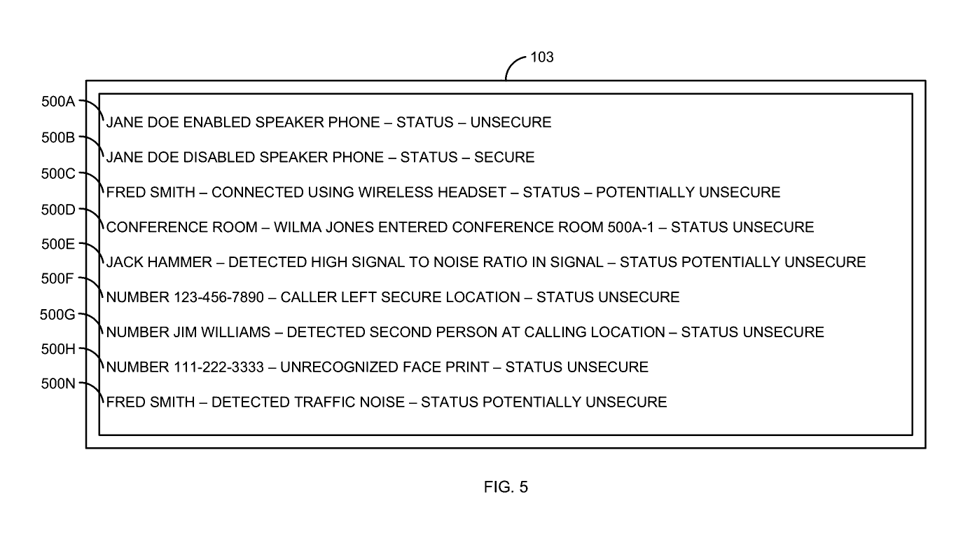

The security manager 104/204, based on the security policy(s) 105/205, builds a message in step 406. The message can vary based on implementation. For example, the message may be to turn a security LED on or off. Alternatively, the message can be based on a descriptive text message, such as, the text messages 500A-500N of FIG. 5. In one embodiment, the message may vary based on the capabilities of the communication endpoint 101 receiving the message. For example, the message sent to the communication endpoint 101A may be to turn off a security LED and the message sent to the communication endpoint 101B may be to display the message 500A.

The security manager 104/204, based on the security policy(s) 105/205, determines the communication endpoints 101A-10N to send the change in the level of security in step 408. For example, the security manager 104/204 may only send the message to a communication endpoint 101A, which is the communication endpoint 101A of a moderator of the communication session. The process then goes to step 312.

FIG. 5 is a diagram of an illustrative display 103 of security messages on a communication endpoint 101. The display 103 comprises security messages 500A-500N. The messages described in FIG. 5 are illustrative examples of events that may occur during one or more communication sessions. One of skill in the art would understand that that the security messages 500 can be displayed in various formats for any of the events described herein.

The security message 500A is for an enabled speakerphone event. The security message 500A indicates that the user Jane Doe enabled her speakerphone resulting in a security level of unsecure. The identity of the user may be captured in various ways, such as using caller ID, voice recognition, facial recognition, RFID card scans, and/or the like.

The security message 500B is for a disabled speakerphone event. The security message 500B indicates that the user Jane Doe disabled her speakerphone resulting in a security level of secure.

The security message 500C is for a connection to wireless headset event. The security message 500C indicates that the user Fred Smith connected to a wireless headset resulting in a security level of potentially unsecure.

The security message 500D is for an unauthorized user event. The security message 500D indicates that Wilma Jones entered the conference room 500A-1. The security manager 104/204 has a list of participants who can be on the call. In this example, Wilma Jones is not in the list resulting in the security level of potentially unsecure.

The security message 500E is for a high signal to noise ratio event. The security message 500E indicates that the audio stream for communication device 101 associated with Jack Hammer has a high signal to noise ratio resulting in the security level of potentially unsecure.

The security message 500F is for a caller leaving a secure location event. The security message 500F indicates that the caller from the endpoint 123-456-7890 has left a secure location (e.g., based on GPS location of a mobile phone) resulting in the security level of unsecure.

The security message 500G is for a second person at a calling location event. For example, the security policy 105/205 may indicate that only a single user (Jim Williams) is the only person allowed to call in from his communication endpoint 101. The second person can be detected via a voice print recognition, audio detection of the second person, video detection of the second person, voice print recognition. The result is that the security level is set to unsecure.

The security message 500H is for an unrecognized facial print event. The security message 500H indicates that the caller for the number 111-222-3333 has an unrecognized face print, resulting in the security level of unsecure.

The security message 500N is for a specific sound event. In this example, the specific sound is traffic noise. The security message 500F indicates that the security manager 104/204 detected the traffic noise in the audio stream of Fred Smith, resulting in the security level of potentially unsecure.

The communication sessions and messages of FIGS. 1-5 may be implemented using a variety of communication protocols, such as SIP, Web Real-Time Protocol (WebRTC), H.323, TCP/IP UDP/IP, video protocols, a combination of these, and the like. Specific message types may be used. For example, SIP SUBSCRIBE/SIP NOTIFY, SIP PUBLISH, SIP OPTIONS messages may be used to send the security messages 500.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
determining that an event changes the security of a communication session between a plurality of communication endpoints, wherein the event that changes the security of the communication session between the plurality of communication endpoints occurs during or after the communication session is established; and
in response to determining the event that changes the security of the communication session between the plurality of communication endpoints, sending a changed security level indication to at least a first one of the plurality communication endpoints.

2. The method of claim 1, wherein determining the event that changes the security of the communication session between the plurality of communication devices is determined in a second one of the plurality communication endpoints and wherein the second one of the plurality of communication endpoints sends the changed security level to the at least first one of the plurality of communication endpoints.

3. The method of claim 2, further comprising:
downloading a security manager and a security policy to the second one of the plurality of communication devices.

4. The method of claim 2, further comprising:
downloading a security manager to the first and second one of the plurality of communication endpoints;
downloading a first security policy to the first one of the plurality of communication endpoints; and
downloading a second security policy to the second one of the plurality of the communication endpoints, wherein the first security policy is different from the second security policy.

5. The method of claim 1, wherein determining the event that changes the security of the communication session between the plurality of communication devices is determined in a centralized security manager and wherein the centralized security manager sends the changed security level to the at least first one of the plurality of communication endpoints.

6. The method of claim 5, wherein the centralized security manager is a Back-to-Back User Agent (B2BUA).

7. The method of claim 1, wherein the event is where a speakerphone has been activated or deactivated in one of the plurality of communication endpoints.

8. The method of claim 1, wherein the event is at least one of: determining a high signal to noise ratio in an audio stream of one of the plurality of communication endpoints, determining a low signal to noise ratio in the audio stream the one of the plurality of communication endpoints, and determining a connection or disconnection of a wireless headset to the one of the plurality of communication endpoints.

9. The method of claim 1, wherein the event is at least one of: determining a person leaving a secure area, determining the person entering the secure area, a visual detection of another person in a room, detection of an unrecognized or unauthorized face print, an audio detection of the another person speaking, detection an unknown or unauthorized voice print, detection of a specific sound, detection of a local recording on one of the plurality of communication endpoints, detection of one of the plurality of communication endpoints leaving the secure area, a door being opened, a door being closed, detection of a person in a nearby area, an motion sensor alarm outside a confidence room, a Global Positioning Satellite (GPS) criteria for a location, and detection of one of the plurality of communication endpoints entering the secure area.

10. The method of claim 1, wherein the sending the changed security level is changed based on a Session Initiation Protocol (SIP) UPDATE message.

11. A system comprising:
a security manager configured to determine that an event changes the security of a communication session between a plurality of communication endpoints, wherein the event that changes the security of the communication session between the plurality of communication endpoints occurs during or after the communication session is established; and
a communication interface configured to send a changed security level indication to at least a first one of the plurality communication endpoints in response to determining the event that changes the security of the communication session between the plurality of communication endpoints.

12. The system of claim 11, wherein determining the event that changes the security of the communication session between the plurality of communication devices is determined in a second one of the plurality communication endpoints and wherein the second one of the plurality of communication endpoints sends the changed security level to the at least first one of the plurality of communication endpoints.

13. The system of claim 12, further comprising:
a policy manager configured to download the security manager and a security policy to the second one of the plurality of communication devices.

14. The system of claim 12, further comprising:
a policy manager configured to download the security manager to the first and second one of the plurality of communication endpoints, download a first security policy to the first one of the plurality of communication endpoints, and download a second security policy to the second one of the plurality of the communication endpoints, wherein the first security policy is different from the second security policy.

15. The system of claim 11, wherein determining the event that changes the security of the communication session between the plurality of communication devices is determined in a centralized security manager and wherein the centralized security manager sends the changed security level to the at least first one of the plurality of communication endpoints.

16. The system of claim 15, wherein the centralized security manager is a Back-to-Back User Agent (B2BUA).

17. The system of claim 11, wherein the event is where a speakerphone has been activated or deactivated in one of the plurality of communication endpoints.

18. The system of claim 11, wherein the event is at least one of: determining a high signal to noise ratio in an audio stream of one of the plurality of communication endpoints, determining a low signal to noise ratio in the audio stream the one of the plurality of communication endpoints, and determining a connection or disconnection of a wireless headset to the one of the plurality of communication endpoints.

19. The system of claim 11, wherein the event is at least one of: determining a person leaving a secure area, determining the person entering the secure area, a visual detection of another person in a room, detection of an unrecognized or unauthorized face print, an audio detection of the another person speaking, detection an unknown or unauthorized voice print, detection of a specific sound, detection of a local recording on one of the plurality of communication endpoints, detection of one of the plurality of communication endpoints leaving the secure area, a door being opened, a door being closed, detection of a person in a nearby area, an motion sensor alarm outside a confidence room, a Global Positioning Satellite (GPS) criteria for a location, and detection of one of the plurality of communication endpoints entering the secure area.

20. A non-transitory computer readable medium having stored thereon instructions that, when executed, cause a processor to perform a method, the instructions comprising:
instructions to determine that an event changes the security of a communication session between a plurality of communication endpoints, wherein the event that changes the security of the communication session between the plurality of communication endpoints occurs during or after the communication session is established; and
instructions to send a changed security level indication to at least a first one of the plurality communication endpoints in response to determining the event that changes the security of the communication session between the plurality of communication endpoints.
